(19) United States
(12) Patent Application Publication
(10) Pub. No.: US 2007/0132408 A1
(43) Pub. Date: Jun. 14, 2007

(54) High frequency driven high pressure micro discharge

(76) Inventors: Manfred Salvemoser, Newark, NJ (US); Daniel E. Murnick, Bernardsville, NJ (US)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 10/567,138

(22) PCT Filed: Jul. 29, 2004
(86) PCT No.: PCT/US04/24737

§ 371 Date: Aug. 4, 2006

Related U.S. Application Data
(60) Provisional application No. 60/492,669, filed on Aug. 5, 2003.

(51) Int. Cl. H01J 17/36; H01J 11/04; H05B 41/00; H05B 37/00

(52) U.S. Cl. 315/326; 315/358

(57) ABSTRACT

A method and apparatus are provided for generating light such as ultraviolet light from excimer-forming gases. Gases are excited by radio frequency alternating current powered electrodes (200, 210) to form excimers that will decay and emit vacuum ultraviolet light. The halogen concentration is optimized so as to optimize emissions from halogen excimers (Z₂*) or mixed rare gas/halogen excimers (RGZ*). Emissions from rare gas excimers (RG₂*) are maximized by maintaining the gas in the discharge region at a relatively low temperature, desirably below 700° K, so that the average kinetic energy of gas particles is less than the vibrational excitation energy of the excimer and substantially less than the dissociation energy of the excimer. Relatively large electrodes (202, 204) can be used to cool the plasma.

### CROSS REFERENCE TO RELATED APPLICATION

This application claims the benefit of U.S. Provisional Application 60/492,669, filed Aug. 5, 2003, the disclosure of which is fully incorporated herein by reference.

### TECHNICAL FIELD

The present invention relates to methods and apparatus for generating light such as ultraviolet light from excimer-forming gases.

### BACKGROUND ART

There has been a need for improved light sources capable of generating ultraviolet light in the spectral region of between about 200 and 400 nanometers wavelength, commonly referred to as the “ultraviolet” or “UV” region and, between about 100 and 200 nanometers wavelength, commonly referred to as the “vacuum ultraviolet” or “VUV” region. VUV light is absorbed by almost all substances, including water and air, and therefore, can only be transmitted in a vacuum. VUV photons have energies on the order of 10 electron volts (10 eV) and are capable of breaking chemical bonds of many compounds. Thus VUV light can be used to accelerate chemical reactions as in chemical vapor deposition, curing of photosensitive material, production of ozone, and cracking gaseous waste products. Moreover, the minimum feature size that can be imaged with light is directly proportional with the wavelength of the light. VUV light has the shortest wavelength of any light that can be focused and reflected with conventional optical elements. Therefore, photographic processes employing VUV lights can image smaller feature sizes than those imaged with other light wavelengths. This is of particular importance in photographic processes used to fabricate semiconductors. In addition, such microimaging of features requires high brightness of light sources with such short wavelengths.

Excimer formation has been used as a source of UV light. Excimers are transient molecules composed of atoms that normally do not combine with one another. One or more of the atoms constituting an excimer is in an excited state, i.e. a state in which the atom has been momentarily promoted to a higher energy state as, for example, by promoting one or more electrons to higher-energy orbitals. The excimer molecule as a whole is also in an excited state; and will ultimately decay to yield the constituent atoms. For example, elements commonly referred to as rare gases or inert gases, helium, neon, argon, krypton, and xenon, which normally exist only as isolated atoms, can form excimers when in the excited state. VUV light is emitted by a radiative process in which the excimer transitions to a lower energy state. Diatomic rare gas excimers such as Ar₂*, Kr₂*, and Xe₂*, emit radiation in the VUV range. Rare gasses can combine with halogens to form excimers that decay and emit VUV light, see Energy flow and excimer yields in continuous wave rare gas-halogen systems, M. Salvermoser and D. E. Murnick, Journal of Applied Physics, Vol. 88, No. 1, pp. 453-459 (Jul. 1, 2000), herein incorporated by reference.

Power must be supplied to create excimers. U.S. Pat. No. 6,052,401, herein incorporated by reference, addresses the use of electron beams to supply the power to gases so as to form excimers and produce VUV light. However, such electron beam approaches typically require creation of an electron beam in a chamber separate from the chamber containing the gases, and introduction of the electron beam through a beam window. The electron beam window apparatus typically imposes some limits on the electron beam power which may be applied to the gases, which in turn imposes limits on the light output power and light intensity. It would be desirable to avoid these limitations. Moreover, it would be desirable to avoid the complication of producing an electron beam when creating the VUV light.

As disclosed in U.S. Pat. No. 6,400,089, herein incorporated by reference, excimers can be formed by applying power through a pair of electrodes disposed in the chamber containing the gases, so as to create a corona effect without arcing between the electrodes. Thus, the electrical power is applied under conditions such that within a part of the space between the electrodes, the electric field is insufficient to substantially ionize the gas. While this approach provides a useful light source, the applied power and hence the light emission are limited by the need to limit the field.

We have previously described certain work with a system in which an electrical discharge is created between electrodes in a space between a pair of electrodes, i.e., so that the gas in the entire space is substantially ionized. Excimers such as ArF* and F₂* are formed under relatively high pressure and with substantial power input, so as to provide an extremely bright, concentrated light source. See Salvermoser, M., Stable High Brightness CW Discharge Lamps at 193 nm (ArF*) and 157 nm (F₂*), GEC 2000 Meeting, Houston, Tex. Other details of the discharge systems using ArF* are reported in Switkes et al., Imaging of 1-nm-thick films with 193-nm microscopy, Optics Letters, 26:15, pp. 1182-1184, Aug. 1, 2001. However, despite all of this progress in the art, still further improvement would be desirable.

### SUMMARY OF THE INVENTION

The present invention addresses this need.

One aspect of the present invention provides a method of producing vacuum ultraviolet light. The method according to this aspect of the invention desirably includes the steps of maintaining a gas mixture containing a halogen capable of forming excimer-like excited halogen molecules of the form Z₂* where Z represents the halogen, or a gas mixture containing a rare gas and a halogen capable of forming excimers of the form RGZ*, where RG represents the rare gas, in a chamber so that at least a portion of the gas mixture is disposed in an emission region between a pair of electrodes at a selected pressure, applying electrical potential between the electrodes to form an electrical discharge in the emission region and apply power to the gases in the emission region at a selected power density, and maintaining a concentration of the halogen in the emission region substantially equal to an optimum concentration. Preferably, the pressure in the chamber is at least about 0.3 bar, and more preferably 0.3 bar to 1.5 bar. The power density in the emission region to generate a bright light source based on Z₂* and RG₂* excimer radiation desirably is at least about 20 kW/cm³. Under typical conditions, the optimum molar concentration of the halogen is between about 1% and about 5% of the total gas mixture, more preferably the halogen concentration is about 2%. Maintaining the concentration of the halogen substantially equal to the optimum concentration of halogen will maximize ultraviolet emission from excimers of the form RGZ* or Z₂* at the selected pressure and power density. The method may further comprise the step of passing the gas mixture through the chamber at a selected flow rate. With this further step, the concentration of the halogen in the gas passed through the chamber is substantially equal to an optimum concentration, which maximizes the ultraviolet emissions at the selected flow rate, pressure and power density.

This aspect of the invention incorporates the discovery that, in generating UV light from rare gas-halogen excimers (RGZ*) or diatomic halogen excimers (Z₂*) under the conditions encountered in an electrical discharge, and particularly in a high-power-density, substantially continuous discharge under relatively high pressures, the concentration of halogen in the discharge region is a significant, result-effective variable which has an optimum value, such that at halogen concentrations substantially equal to this optimum value, the intensity of emissions is much greater than that achieved at other concentrations. Where gases are passed through a chamber, the amount of halogen in the gas mixture is closely correlated to the concentration of halogen in the emission region, and shows a similar optimum. Although the present invention is not limited by any theory of operation, it is believed that these results arise from competition between increases in excimer formation with increasing halogen concentration and increases in undesirable side reactions between halogen and RGZ* or Z₂* excimers and the unexcited halogen molecules with increasing halogen concentration. These side reactions cause decay of the excimers without emission of the desired UV light.

Another aspect of the present invention provides an apparatus for producing vacuum ultraviolet light in accordance with the method of this embodiment. The apparatus is comprised of a chamber containing two electrodes, which define an emission region, a gas at a selected pressure within the chamber, and a power source for providing electrical potential to the electrodes so that an electrical discharge is formed in the emission region. The gas is comprised of a halogen such as fluorine which will form Z₂* excimers or a mixture containing the rare gas and a halogen that will form an excimer of the form RGZ*. The power source provides a power density between the electrodes, and the gas contains an amount of halogen so that the concentration of the halogen in the emission region is substantially equal to an optimum concentration that will maximize ultraviolet emissions from the excimers at the selected pressure and the power density. The apparatus may further comprise a gas source and the chamber may have an inlet opening connected to the gas source and an outlet opening. The gas source, the inlet opening and the outlet opening are adapted to pass the gas through the chamber at a flow rate. The gas contains an amount of halogen substantially equal to an optimum amount that will maximize ultraviolet emissions at the flow rate, the selected pressure, and the power density. A portion of the chamber desirably is transparent to ultraviolet emissions from the RGZ* excimers, so that the emitted light can be used outside of the chamber.

Another aspect of the present invention provides further methods of producing vacuum ultraviolet light. This method desirably includes the steps of maintaining a gas that contains a rare gas in a chamber with at least a portion of the gas disposed in an emission region between a pair of electrodes; applying electrical potential between the electrodes to form an electrical discharge in the emission region between the electrodes, which will apply power to the gas in the emission region such that a plasma is formed in said emission region, and maintaining gas in the discharge region at a temperature such that the population of high lying vibrational levels near the binding energy of the RG₂*-molecule are not populated significantly. Most preferably, the temperature is selected so that the average kinetic energy of the gas atoms in the discharge region is such that RG₂* does not rapidly dissociate. Ideally, the temperature is selected so that the average kinetic energy in the gas in the discharge region is less then the vibrational excitation energy of RG₂* excimers. The plasma emits ultraviolet light by a radiative process including transition of excimers of the form RG₂* to a lower-energy state. In this method as well, the method optionally may include the step of passing the gas through the chamber at a selected flow rate. The gas may include one or more rare gases such as Xe, Ar, Ne, or He alone, in which case the emission is substantially that radiated upon direct decay of the RG₂* excimers. In a further aspect of the present invention, the gas includes hydrogen and neon, and the radiative process includes energy transfer from Ne₂* excimers to monatomic hydrogen present in the discharge, so that the light is emitted primarily from the excited monatomic hydrogen.

Methods according to this aspect of the invention incorporate the discovery that emission intensity from processes involving RG₂* excimers in an electrical discharge can be substantially improved by limiting the temperature in the discharge region. Although the present invention is not limited by any theory of operation, it is believed that at temperatures which exceed about 700° K, emission is impaired by undesired thermally induced collisional dissociation of excimer molecules in vibrationally highly excited states. The temperature can be limited by using relatively large-area electrodes, which limit the discharge power per unit area of electrode surface and per unit volume of the discharge region. The large electrodes also provide increased heat transfer from the discharge to the electrodes. Preferably, the electrical discharge power per unit of surface area of each electrode is about 1.0 W/mm² or less. The electrodes may have substantially spheroidal surfaces confronting the discharge region.

Yet another aspect of the present invention provides an apparatus for producing vacuum ultraviolet light using RG₂* excimers. The apparatus in accordance with this aspect of the invention includes a chamber containing two electrodes that define an emission region there between, and a gas within the chamber, the gas being comprised of a rare gas that will form an excimer of the form RG₂*, where RG represents said rare gas. The apparatus further includes a power source for providing electrical potential to the electrodes so that an electrical discharge is formed in the emission region between the electrodes. A plasma is formed in the emission region such that the plasma emits ultraviolet light by a radiative process including transition of excimers of the form RG₂* to a lower energy state, and a temperature is maintained in the emission region such that the gas in the discharge region is at a temperature that population of highly excited vibrational levels close to the binding energy of RG₂* excimers is suppressed. The apparatus ideally also maintains the temperature in the emission region so that the average kinetic energy is less than the vibrational energy of the excimers.

### BRIEF DESCRIPTION OF THE DRAWINGS

A more complete appreciation of the subject matter of the present invention and the various advantages thereof can be realized by reference to the following detailed description in which reference is made to the accompanying drawings in which:

FIG. 1 is a schematic diagram of an apparatus for creating VUV light in accordance with one embodiment of the present invention.

FIG. 2 is a schematic diagram of a circuit used in the apparatus of FIG. 1.

FIG. 3 is a schematic diagram of electrodes used in accordance with one embodiment of the present invention.

FIG. 4 is a schematic diagram of electrodes used in accordance with another embodiment of the present invention.

FIG. 5 is a schematic diagram of electrodes used in accordance with another embodiment of the present invention.

FIG. 6 is a graph showing the output wavelength of an example of the present invention.

FIG. 7 is a graph showing the output power over a period of time of an example of the present invention.

FIG. 8 is a graph showing the output wavelength of an example of the present invention.

FIG. 9 is a graph showing the output power over a period of time of an example of the present invention.

FIG. 10 is a graph showing the output wavelength of an example of the present invention.

FIG. 11 is a graph showing the output wavelength of an example of the present invention.

FIG. 12 is a graph showing the output power over a period of time of an example of the present invention.

FIG. 13 is a graph showing the output wavelength of an example of the present invention.

FIG. 14 is a graph showing the output power over a period of time of an example of the present invention.

### DETAILED DESCRIPTION

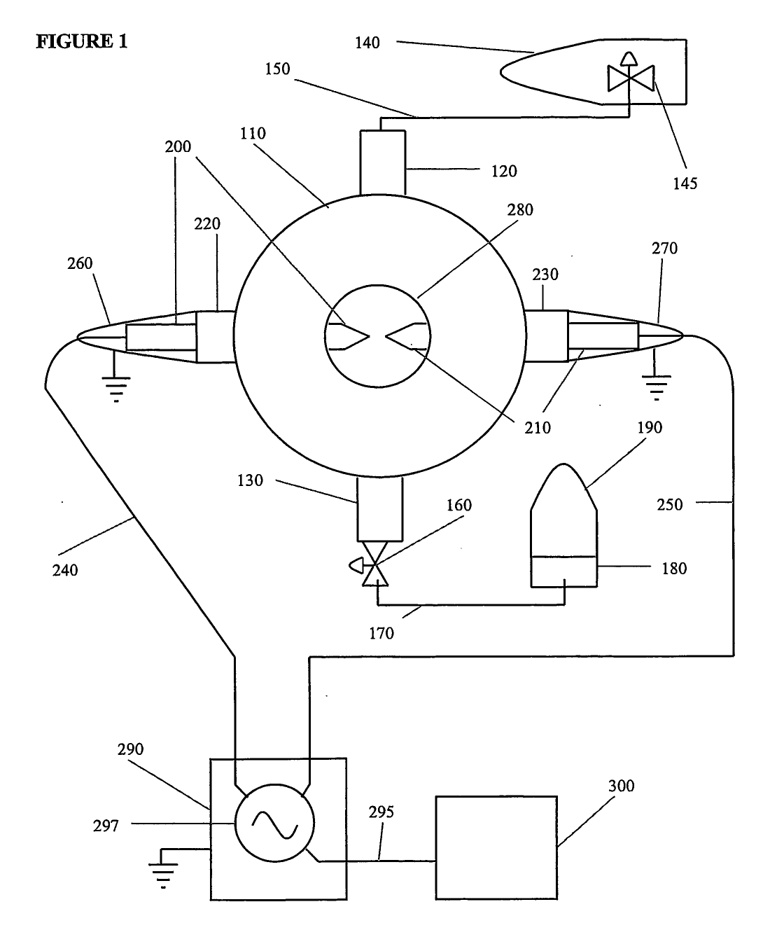

An apparatus in accordance with one embodiment of the present invention is depicted in FIG. 1. The apparatus includes a chamber 110 having an inlet opening 120 and an outlet opening 130 for allowing a gas to move through chamber 110. Chamber 110 may have walls made of aluminum. The chamber has a wall portion or window 280 that is transparent to ultraviolet or vacuum ultraviolet emissions that will be emitted within the chamber, as discussed below. Window 280 may be made of CaF₂ or MgF₂. A gas source 140 such as a gas cylinder having a valve 145 for controlling the output of gas from gas source 140 is connected to a tube 150 or other similar means for conveying the gas inside gas source 140 to a desired location. Tube 150 may be flexible tubing, such as flexible Swagelok® PFA tubing, and should be inert to the gas inside gas source 140. Tube 150 is connected to inlet opening 120, so that the contents inside gas source 140 can flow through tube 150 into chamber 110. A valve 160 is connected to outlet opening 130. Valve 160 may be a needle valve, and is used to control the flow rate of the gas out of chamber 110, thereby, controlling the pressure inside chamber 110. A tube 170, or other similar means for conveying the gas inside chamber 110 to a desired location, is connected to valve 160. Tube 170 may be flexible tubing, such as flexible Swagelok® PFA tubing, and should be inert to the gas inside gas source 140. Tube 170 is connected to a pump 180. The gas flows through pump 180 to a container 190 having an exhaust opening. Container 190 may be a stainless steel container filled with wet Coelithe, which acts as a scrubber.

A pair of electrodes, individually 200 and 210, is positioned within chamber 110 and held in fittings 220 and 230. Fittings 220 and 230 may be Cajon® Ultra-Torr® fittings that allow the tips of electrodes 200 and 210 to be centered in chamber 110 and are sealed or fitted such that substantially no gas will escape or enter chamber 110 through fittings 220 and 230. The tips of electrodes 200 and 210 should be about 0.3 mm to about 1 mm apart from each other in chamber 110. Cables 240 and 250 connect to electrodes 200 and 210, respectively. Cables 240 and 250 may be coaxial cable. The portion of electrodes 200 and 210 that remain outside of chamber 110 are covered with radio frequency (RF) shields 260 and 270, respectively, to minimize RF noise emissions from the apparatus. The outside shielding of cable 240 is connected to RF-shield 260, and the outside shielding of cable 250 is connected to RF-shield 270. The body of chamber 110 should also be connected to either RF-shield 260 or RF-shield 270. The body of chamber 110, the outside shielding of cable 240, the outside shielding of cable 250, RF-shield 260, and RF-shield 270 are grounded.

A power supply 300 is connected via cable 295 to an oscillator circuit 297, which may be contained in a grounded shield 290 such as a metallic box. Power supply cable 295 also may be a coaxial cable. Cables 240 and 250 are connected to oscillator circuit 297 contained in shield 290.

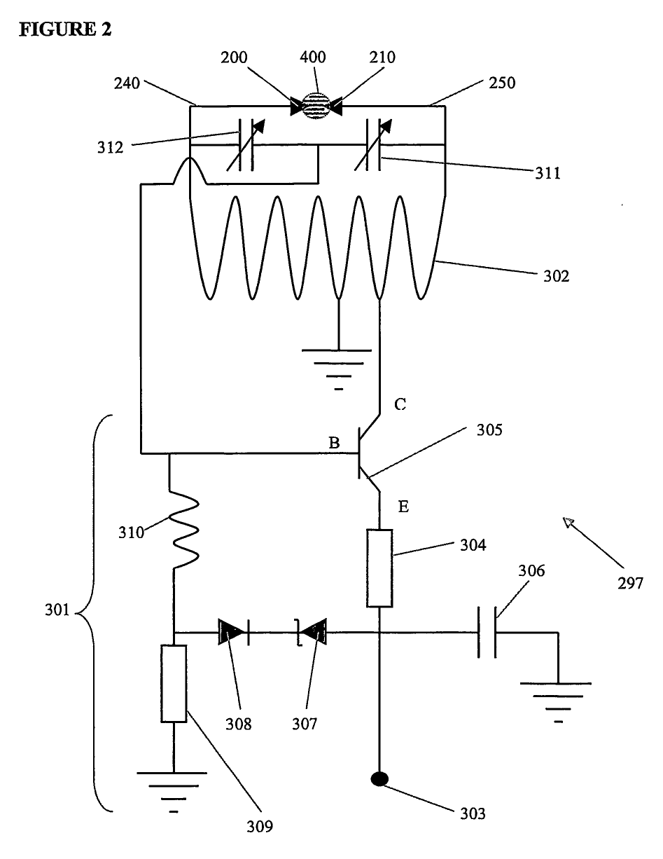

Oscillator circuit 297 inside shield 290 is shown in FIG. 2. In this exemplary oscillator circuit, the current from power supply 300 is chopped by an RF-transistor 305 into a pulsing radio frequency-alternating current (RF-AC), which is stepped up in voltage by an RF-transformer 302. Transformer 302 may be a RF-transformer with a primary to secondary ratio of 2:50. Cable 295 connects to oscillator circuit 297 at a connection 303. Resistor 304 may be a 20 Ohm resistor. Transistor 305 may be a Motorola® npn-transistor MRF429. Capacitor 306 may be a 10 μF capacitor. Diode 307 may be a 1N4001 zener diode. Capacitor 308 may be a 1N5234B capacitor. Resistor 309 may be a 620 Ohm resistor. Inductor 310 may be a 100 μH inductor. Capacitor 311 and capacitor 312 may be adjustable capacitors with adjustable values of 0.8 to 16 pF.

Power supply 300 provides direct current (DC) to the oscillator circuit inside shield 290. The DC power should be in the range of about 0 to 50 volts. The inside of cable 295 provides negative potential to the oscillator circuit by being connected to the negative power output of power supply 300. This will provide 0 to −50 volts to oscillator circuit 297. The shielding of cable 295 is connected to the positive power output of power supply 300, and the positive power output of power supply 300 is connected to ground potential. Oscillator circuit 297 includes a low-voltage oscillator portion 301 which transforms the negative power output of power supply 300 into about 6 MHz pulsing RF-AC current, and transformer 302 which steps up the voltage of such current. The RF-AC current provides an electric potential to electrodes 200 and 210. Electrodes 200 and 210 create an electrical discharge 400 between and around the electrodes, which will apply power to any gas disposed between the electrodes within the electrical discharge. It should be appreciated that the constructional details of the chamber, gas supply and oscillator shown in FIGS. 1 and 2 are merely illustrative. For example, as discussed below, the emissions can be obtained with or without gas flow through the chamber. If no flow is required, the gas source can be omitted, and the chamber can be provided as a sealed unit with the desired gas permanently sealed therein. Such an arrangement can be advantageous, for example, to provide a sealed unit suitable for use as a lamp in industrial apparatus.

In operation of the apparatus of FIGS. 1 and 2, chamber 110 typically is evacuated and flushed a few times with gas from source 140 to remove any impurities inside chamber 110. Gas flow from gas source 140 is introduced into chamber 110 and flows through the chamber, so that a portion of the gas passes through the electrical discharge region between electrodes 200 and 210. Adjusting valves 145 and 160 will adjust the pressure inside of chamber 110 and the flow rate through the chamber.

Typically, at startup chamber 110 is filled with approximately 300 mbars of the desired gas mixture. Power supply 300 is turned on to about 30 volts so that oscillator circuit 297 applies about 1000 volts across electrodes 200 and 210. If these conditions do not produce an electrical discharge between the electrodes, power supply 300 can be turned up to between about 45 volts and 50 volts for a short period of time or until the discharge starts. If the discharge still has not started, valve 145 should be closed and valve 160 should be opened, which will produce a pressure drop in chamber 110, and the discharge should automatically start. Once the discharge starts, valves 145 and 160 should be adjusted to slowly bring chamber 110 to the desired operating pressure preferably between about 600 mbars and about 1 bar total pressure and flow rates. Once the apparatus is running, the power density in the emission region can be set to a desired value by setting power supply 300 to an output voltage, typically between about 20 volts and about 35 volts on power supply 300, corresponding to about 500 to about 1500 volts across electrodes 200, 210. Typically, the apparatus is operated for about 5 to about 10 minutes to establish a stable pressure and gas flow. At a fixed flow rate and fixed supply voltage, the apparatus runs at a stable output level as long as the pressure inside chamber 110 stays constant. The apparatus can also run at no gas flow by closing valve 160, and opening valve 145. Once the desired pressure is obtained in chamber 110, then valve 145 can be closed. This will provide an environment in chamber 110 with no gas flow, but a constant pressure.

The electrical potential applied to electrodes 200 and 210 creates an electrical discharge in a discharge region 400 between electrodes 200 and 210. Thus, the electric field between the electrodes accelerates free electrons in the gas within the discharge region, which in turn impact on gas atoms and molecules and dislodge additional free electrons, so that the gas within the discharge region forms a plasma or mixture containing a substantial proportion of ionized species and free electrons. Under these conditions, excimers form. The plasma is a dilute plasma, which contains ionized gas atoms and free electrons embedded in a dense background of neutral gas atoms and molecules present in the discharge region.

The desired excimer emission to be produced is determined by the gas fill, concentration or gas flow, and electrode type used in the apparatus. By selecting specific gases, desired excimers will be formed and will decay emitting VUV light through window 280. Rare gases (RG) and halogens (X) can combine to form excimers, RGX* that will emit VUV light. Rare gases include: helium (He), neon (Ne), argon (Ar), krypton (Kr), xenon (Xe), and radon (Rn). Halogens include: fluorine (F), chlorine (Cl), bromine (Br), iodine (I), and astatine (At). For example, argon and fluorine combine to form the excimer ArF*, which will produce VUV light at a wavelength of 193 nm. Also, a gas mixture of a rare gas and a halogen can form a diatomic halogen excimer, X₂*. For example, He and F₂ as well as Ne and F₂ will produce F₂*, which will emit VUV light at a wavelength of 157 nm. Rare gasses alone can also form diatomic excimer molecules, RG₂*, which will emit VUV light. Examples of diatomic rare gas excimer molecules are Xe₂* that will produce VUV light at a wavelength of 172 nm, Kr₂* that will produce VUV light at a wavelength of 145 nm, Ar₂* that will produce VUV light at a wavelength of 130 nm, and Ne₂* that will produce VUV light at a wavelength of 80 nm. Another example of the present invention is an excimer H* that will produce VUV light at a wavelength of 121.6 nm, which is monochromatic Lyman Alpha light based on a nearly resonant energy transfer process from Ne₂* to hydrogen.

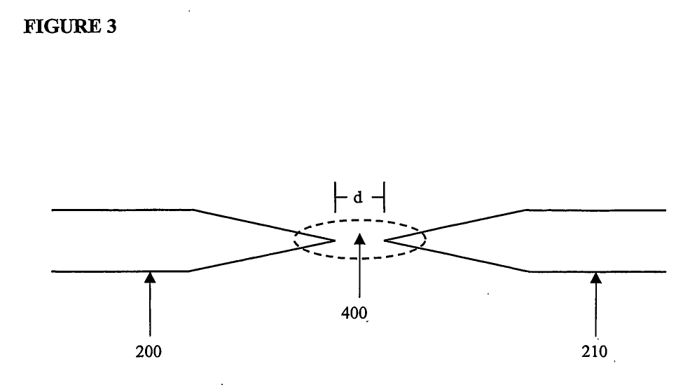

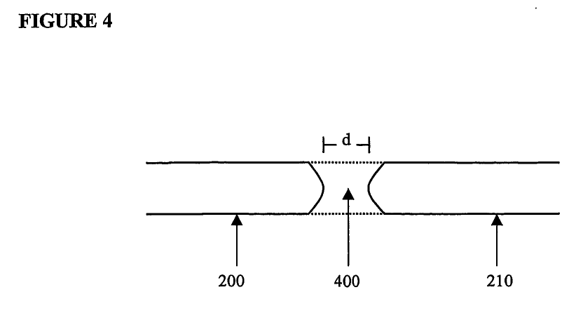

In a method according to one embodiment of the invention, the gas mixture includes a rare gas and a halogen, and excimers of the form RGZ*, where RG represents the rare gas and Z represents a halogen, are formed in the discharge. In this embodiment, the electrodes 200, 210 desirably have a pointed configuration as seen in FIG. 3 or a rounded configuration as seen in FIG. 4. Pointed electrodes, as depicted in FIG. 3, create a stronger electrical field at the points, which eases the initiation of the discharge. This type of electrode can be made of, for example, brass or stainless steel needles mounted in a suitable holder with connections for the electrical cables. The tips of the electrodes should be separated by distance d, preferably between about 0.3 mm and 0.7 mm. The VUV light discharge starts easily and generates a small, bright point light source due to sharp electrodes.

The electrodes may also be rounded at the ends as shown in FIG. 4. The rounded electrodes are shaped such that the ends are convexly shaped and are substantially rounded. The ends of the electrodes should be separated by distance d, which is preferably about 0.3 mm to about 0.7 mm. The electrodes desirably are formed from rods or wires of about 0.75 mm diameter or less, most preferably about 0.5 mm diameter. These electrodes also are desirably formed from brass or stainless steel. The rounded electrodes generate a slightly larger emission region 500 than the needle-tip electrodes. It is slightly more difficult to start the discharge due to lower electric field strength at the electrode ends because the ends are not a point but a rounded shape.

Most preferably, in this embodiment the apparatus is operated so that the electrical power dissipation per unit volume in the discharge region is at least about 10 kW/cm³. In calculating the electrical power dissipation per unit volume for a unit employing pointed electrodes (FIG. 3) or rounded electrodes (FIG. 4), the volume of the discharge region can be taken as the volume of a sphere having a diameter equal to the distance d between the electrode tips. The electrical power applied to the discharge is simply the amount of power applied through the electrodes, i.e., the integral of the product of the instantaneous voltage across the electrodes and the instantaneous current flow over a period of time divided by the duration of such period. The total gas pressure in the chamber desirably is at least about 0.3 bar, and more preferably at least about 0.8 bar. The gas mixture present in the chamber may consist entirely of the rare gas and halogen which form the excimer, but more preferably includes a diluent gas such as He which stimulates formation of the RGZ* excimers by transferring energy to the rare gas atoms, but does not appreciably participate in quenching reactions with such RGZ* excimers. The diluent gas may be present in an amount of up to about 90% of the total gas mixture. The remainder of the gas mixture desirably consists of the excimer-forming rare gas and the halogen. The gas mixture may flow through the chamber or else may be sealed within the chamber after filling the chamber. Where a non-zero gas flow rate (in units of standard cubic centimeters per minute=sccm) is employed, the same is preferably at least 30 sccm.

In this embodiment, the amount of halogen present in the gas mixture within the chamber is an important factor in the output of ultraviolet light from the apparatus. There is an optimum concentration of halogen that can be present in the chamber that will give the best results in emitting VUV light for any set of conditions. That is, for a gas mixture incorporating a given rare gas RG and halogen Z, and at a given flow rate of the gas mixture through the chamber (which may be zero or a given non-zero flow rate), and at a given pressure within the chamber, and a given power density in the emission region between the electrodes, the VUV light output by emission from excimers of the form RGZ* will be at a maximum at a particular concentration of the halogen in the gas mixture. That particular concentration is referred to herein as the optimum concentration. For a given set of conditions, the optimum concentration can be determined by measuring the light output with different concentrations. Under the conditions typically used, the optimum concentration ordinarily lies between about 1% and about 5%, and most typically about 2%. The concentrations referred to herein are molar concentrations, and are measured outside of the emission region, where the rare gas is present as monatomic rare gas and where the halogen is present as diatomic molecules. Also, as used in this disclosure, a given concentration is referred to as “substantially equal” to the optimum concentration if the given concentration results in a VUV light output at least 50% of that observed with the optimum concentration under otherwise identical conditions. More preferred gas mixtures are those closer to the optimum concentration result in light output of at least 75% of the light output observed with the optimum concentration and most desirably at least 90% of the optimum concentration.

Although the present invention is not limited by any theory of operation, it is believed that there is an optimum halogen concentration because of the following actions. There is a primary energy transfer from the electrons in the electrical discharge of the electrodes to the rare gas from two reactions:
RG+e⁻→RG*+e⁻ (I)
RG+e⁻→RG⁺+2e⁻ (II)

Additionally, electrons can dissociate the halogen (Z):
Z₂+e⁻→Z+Z⁻ (III)

Rare gas molecules, excimers, are formed from three body collisions with metastable rare gas atoms from Formula I, or via molecular ions from Formula II, or
RG⁺+2RG→RG₂⁺+RG (IV)

Excimers are then formed:
RG₂⁺+e⁻RG*+RG (V)
RG*+2RG→RG₂*+RG (VI)

In the ArF* example, the excimer can be formed:
Ar₂*+F₂→F+Ar+ArF* (VII)
Ar₂⁺+F⁻→Ar+ArF* (VIII)
Ar*+F₂→F+ArF* (IX)
Ar⁺+F⁻+Ar→Ar+ArF* (X)

The ArF* can either emit a 193 nm photon or it can be nonradiatively quenched by the following processes:
ArF*+2Ar→Ar₂F+Ar* (XI)
ArF*+Ar→products (XII)
ArF*+F₂→products (XIII)

Formulas XI-XIII decrease light output and limit efficiency of the 193 nm light production at high Ar and F₂ partial pressures. As a result, there is an optimum concentration of the halogen needed to produce VUV light given a fixed pressure and power density because there is a balance between needing an amount of the halogen sufficient for the RGX* excimer to form, but not having an excess amount of the halogen such that the RGX* excimer is prevented from radiating by quenching side reactions before it can produce the ultraviolet photon.

The rate of gas flow, if any, through the chamber, can also influence the optimum concentration of halogen. That is, the optimum halogen concentration at a non-zero flow rate of the gas mixture through the chamber typically will be lower than the optimum concentration at a zero flow rate. In this respect as well, the present invention is not limited by any theory of operation. However, it is believed that at a non-zero flow rate, the concentration of diatomic halogen in the emission region, where the reactions occur, is increased to some degree by increased mass transport from the other regions of the chamber. Therefore, a given concentration of diatomic halogen molecules in the gas mixture within the chamber will result in a higher concentration of diatomic halogen molecules in the emission region.

In a second embodiment, a diatomic halogen excimer, Z₂*, most preferably F₂*, is produced under similar conditions and requirements as the RGZ* rare gas and halogen excimers. In this embodiment, the gas mixture preferably consists of the halogen and a diluent gas such as helium or neon, which stimulates excimer formation by transferring energy to the halogen molecules, but does not react appreciably with the excimers after their formation. In this system as well, there is an optimum concentration for any set of other conditions (pressure, power density and gas flow rate). Here again, it is believed that the existence of the optimum results from the competing effects of the increase in excimer formation with increasing halogen concentration and the increase in non-radiative quenching reactions with increasing halogen concentration. For example, the F₂* excimer (157 nm) can be formed by providing helium and fluorine in the chamber. Under typical conditions, the molar concentration of fluorine is between about 1 and about 5%, more preferably, about 2% of the total gas mixture.

In a third embodiment, rare gases combine to form diatomic excimer molecules of the formula RG₂*. An important factor in emission of ultraviolet light in this embodiment is the temperature of the gas where the excimers form. The gas molecules in the discharge region are in a distribution with populations of different vibrational states. These different vibrational states are dependent upon temperature, such that the higher the temperature, the greater the population of gas molecules that have higher vibrational states, which will lead to dissociation of the RG₂* excimer prior to radiation of the VUV light. For rare gas excimers of the formula RG₂*, the gas temperature in the discharge region must be kept such that the average kinetic energy of the gas particles in the discharge region is such that there is only a negligibly small equilibrium population of vibrationally highly excited RG₂* molecules with vibration energy levels close to the binding energy of the RG₂* excimer. The binding energy of the RG₂* excimer is the energy level required to decompose the RG₂* excimer into its components, a RG atom in the ground state and a RG* atom in an excited state separated by a distance much larger then their respective atomic radii. Keeping the average temperature and average kinetic energy low helps to limit dissociation of the excimers, which would impair the emission process. Preferably, in this embodiment the temperature of the gas atoms and molecules is such that the average kinetic energy of the gas particles in the discharge region is less than the vibrational excitation energy of the RG₂* excimers. The excimers, like any other multiatomic moiety, have vibrational states. In a ground vibrational state, the nuclei of the atoms constituting the excimer are relatively close to one another. In higher vibrational states, the nuclei are further from one another. The desired emission of the RG₂* excimer molecule arises from transition of an electron from a higher energy state or electronically-excited state to a lower energy state while the excimer is in a particular vibrational energy state. The energy required to promote the excimer from the ground vibrational state a higher vibrational state is referred to herein as the vibrational excitation energy. Keeping the average kinetic energy of the gas atoms within the discharge region below the vibrational excitation energy minimizes vibrational transitions of the excimers into higher lying vibrational states ultimately leading to dissociation and hence, maximizes VUV light emissions. For typical rare gas excimers, a plasma temperature of below about 700° K provides average gas atom kinetic energy less than the vibrational excitation energy and less than the binding energy, so that the RG₂* excimer will not dissociate.

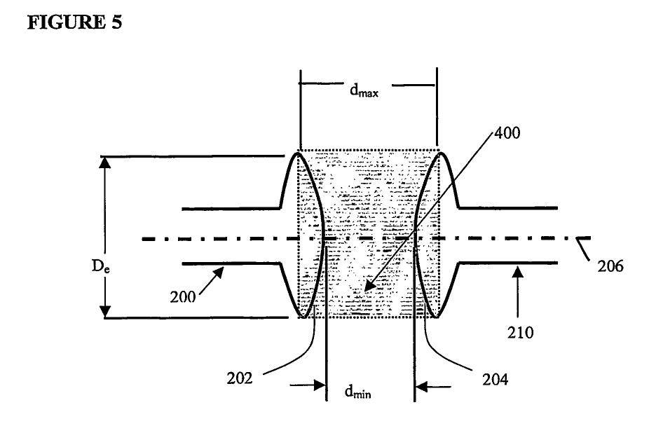

The method and apparatus used in this embodiment are generally similar to the methods and apparatus discussed above with reference to halogen-containing gases. Here again, the gas is maintained in the chamber 110 so that at least a portion of the gas is disposed between the electrodes 200, 210 in the emission region 400. Here again, electrical potential is applied to the electrodes so that the electrodes can apply power to the gas in the emission region. A plasma forms in the emission region, which is where substantially all of the excimer will form. In this embodiment, however, the electrodes 200, 210 desirably have the configuration depicted in FIG. 5. The electrodes used in this arrangement desirably are made of a metal such as stainless steel. In the configuration of FIG. 5, the ends of the electrodes confronting one another define surfaces 202, 204 having substantial area confronting one another and defining the excitation region 400 therebetween. For example, the ends of the electrodes may have a diameter De of about 1 mm or more, so as to provide surface areas of at least about 0.75 mm² confronting the emission region 400. The electrodes may be spaced apart from one another by a minimum spacing don of about 0.7 mm to about 1.0 mm. The surfaces of these electrodes may have a spheroidal shape such that each one of the surfaces 202, 204 confronting the emission region slopes outwardly, away from the emission region in a radially outward direction, away from a central axis 206 extending through the emission region. Desirably, this slope is small, so that the maximum spacing dₘₐₓ between the electrodes, at the outer edges of the electrodes, differs from the minimum spacing dₘᵢₙ by about 30% or less. In a variant of this configuration, the electrode surfaces confronting the emission region may be substantially flat, disc-like or plate-like surfaces. Such electrodes will provide effective cooling, but make it more difficult to initiate the discharge.

The large electrode size spreads the plasma area out over an emission region 400 having greater volume than the emission region encountered with pointed or small-diameter rounded electrodes as shown in FIGS. 3 and 4. With spheroidal electrodes as shown in FIG. 5, the emission volume approximates a cylinder having diameter equal to the electrode diameter Dₑ and a height equal to (dₘᵢₙ+dₘₐₓ)/2. This has the effect of spreading out the plasma and lowering the power density per unit volume in the emission region, which helps establish a lower temperature than a near point source electrode would allow. For example, in this arrangement the power density, calculated on the basis of the cylindrical approximation, may be about 0.1 kW/cm³ to about 5 kW/cm³. The relatively large, flat or gently sloping electrodes tend to spread the applied power over the surfaces of the electrodes, which tends to minimize the temperature of the plasma. One useful parameter to describe systems using such electrodes is the power density per unit surface area. As described in this disclosure, the power density per unit surface area is the applied electrical power divided by the surface area of the exposed surface of one electrode. Most desirably, the power density per unit surface area in systems employing RG₂* excimers is below 10 W/mm², most preferably 1 W/mm² or less. It is also believed that the relatively large, cool surfaces of the electrodes in proximity to the plasma tend to cool the plasma as, for example, by conduction. In variants of this embodiment, additional or substitute measures can be employed to cool the plasma. For example, heat transfer to the electrodes can be enhanced by measures which reduce the temperature of the electrodes themselves as, for example, circulating a chilled coolant in contact with surfaces of the electrodes remote from the plasma. Also, additional heat transfer from the plasma can be obtained by providing additional cold elements in close proximity to the plasma. For example, the chamber may be of relatively small size so that the walls of the chamber are disposed close to the emission region, and the housing can be cooled by an external cooling system. In a further variant, an additional cold structure may be positioned within the chamber in proximity to the emission region. In yet another variant, the cold structure may serve as a reflector to direct the emitted light out of the chamber.

The RG₂* excimers include Xe₂*, Kr₂*, Ar₂* and Ne₂*. The gases fill in the chamber used to form these excimers may be the pure rare gas, or may include a diluent gas such as helium, which does not substantially interact with the rare gas excimers. It is desirable to minimize contaminants in the gas mixture within the chamber. In order to avoid rare gas contamination due to out gassing from the chamber walls, a small gas flow is preferable, about 0.5 to about 10 sccm. This flow rate should be about the amount of gas such that the gas volume within the chamber is changed in about 1 to about 10 minutes. However, if the chamber is composed of materials which do not appreciably outgas, the system will operate acceptably with no flow, i.e., with the gas sealed within the chamber. Also, the chamber may be provided with a “getter” or internal structure, which reacts with outgassed contaminants. The gas pressure within the chamber desirably is about 300 mbar to about 1.5 bar.

A Ne₂* excimer can be produced in this embodiment. The Ne₂* excimer emits light at a wavelength of about 80 nm. This wavelength is so small that it is difficult to find a window or other means for transmitting the light from inside the chamber to outside the chamber. If there is a desired surface that is to be irradiated with this light, it can be placed inside the chamber. In a further variant, the gas mixture includes hydrogen together with neon. In this embodiment, the radiative process involves a nearly resonant energy transfer process from Ne₂* to hydrogen. Instead of the radiative process of the Ne₂* excimer emitting a photon of 80 nm light, the Ne₂ excimer transfers the energy to hydrogen forming an excited monatomic hydrogen H*. The excited hydrogen H* emits light at 121.6 nm, which is monochromatic Lyman alpha light. There is a broad range of hydrogen concentrations allowable to produce the H* excimer, preferably 0.1 mbar to 15 mbar hydrogen in about 300 mbar to about 1 bar neon.

In the embodiments discussed above, the power applied to the electrodes preferably is alternating potential at radio frequency. Radio frequency covers a significant portion of the electromagnetic spectrum, extending from about 10 kHz to about 300 GHz. The frequency preferably is at least about 100 kHz, as, for example an RF AC potential at a frequency of about 6 MHz powers the electrodes. The use of an RF potential is particularly preferred in those embodiments where the gas mixture includes a halogen such as fluorine. Use of an RF potential substantially prevents corrosion of the electrodes, and thus extends the life of electrodes and the length of time the apparatus can continuously run. For example, systems using RF-AC excitation can operate continuously for days or more with stable light output power. The change in output power with time ΔP desirably is about 3% or less of the original output power over a time period of 10 minutes. Here again, the present invention is not limited by any theory of operation. However, as mentioned above, the reactions in the plasma state typically include formation of species such as monatomic F. Recombination of monatomic F with free electrons in the plasma forms F⁻ ions. In a DC discharge, these F⁻ ions drift to the anode and cause severe corrosion. It is believed that RF discharge reverses the field before the F⁻ ions can drift to the electrode momentarily serving as the anode. Thus, the RF discharge effectively reduces this corrosion. The apparatus will work using DC power, however, there will be a significant drop in the life of electrodes and the length of continuous emission of VUV light.

The following non-limiting examples illustrate certain features of the invention. Except as otherwise indicated, these examples employed apparatus as discussed above with reference to FIGS. 1 and 2:

### EXAMPLE 1

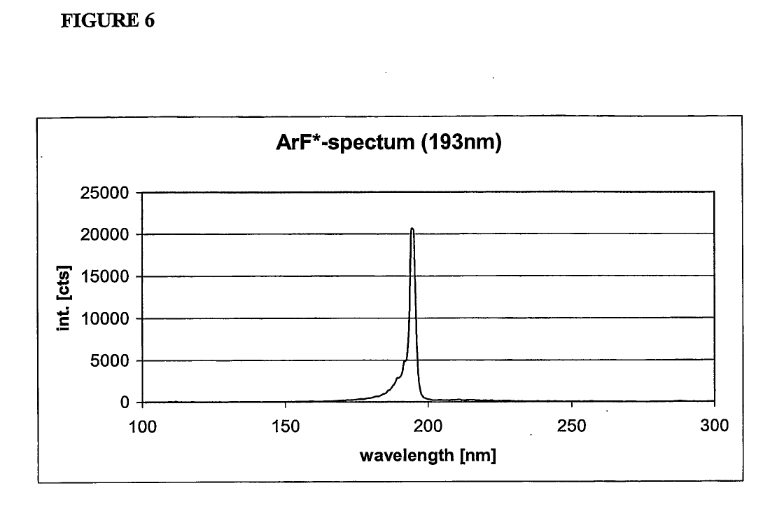

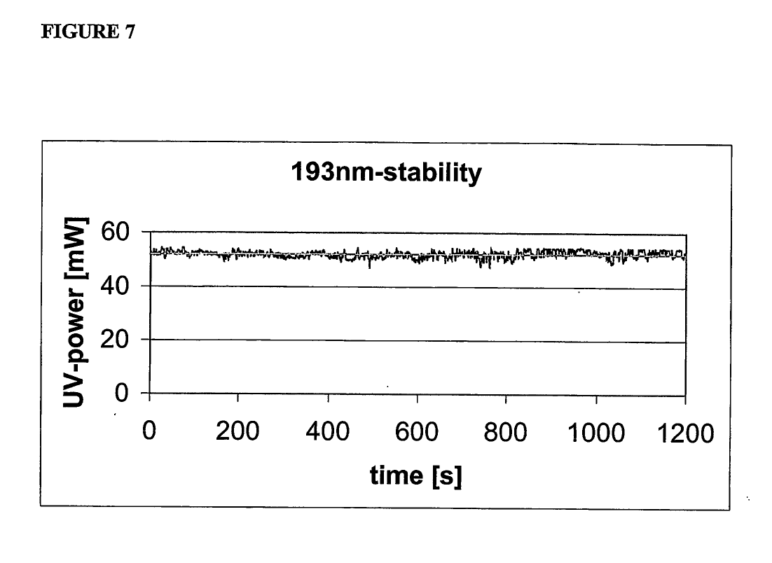

68% He, 30% Ar, and 2% F₂ at 500 mbar total pressure was used to form the ArF* excimer and produce 193 nm light, with brass needle tip electrodes as shown in FIG. 3. The gas flow through the chamber was less than 60 sccm flow of the gas. The voltage was set at 24 volts at the power supply, supplying −24 volts to the oscillator circuit. FIG. 6 shows the intensity of the output from the apparatus vs. the wavelength output from the apparatus, and FIG. 7 shows the light power output of the apparatus over a period of time. Similar results were obtained using less rounded brass electrodes at about 1 bar total pressure and at 30 volts at the power supply.

### EXAMPLE 2

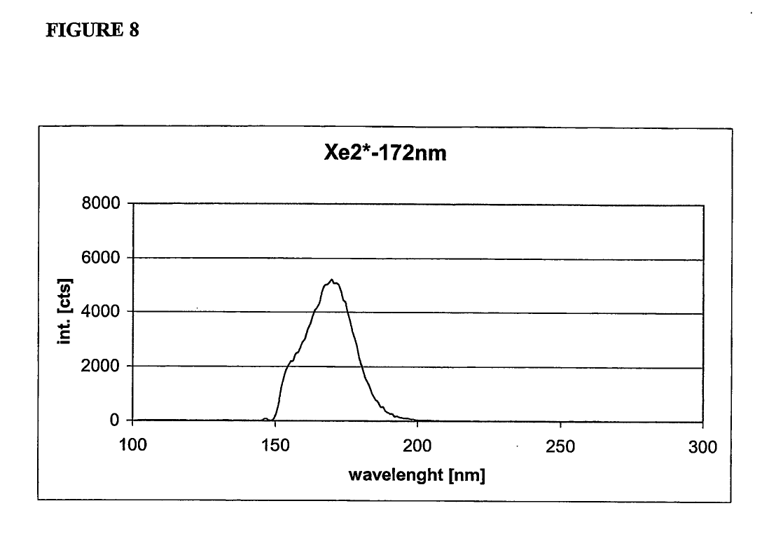

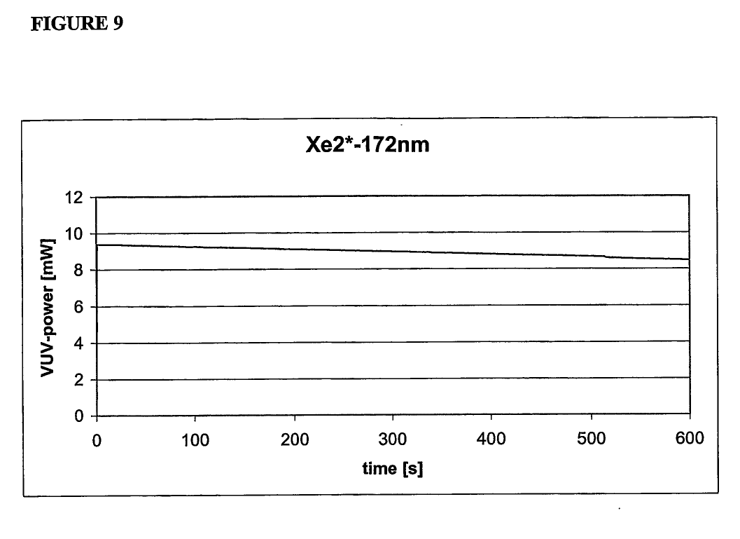

Pure Xe of research grade at 800 mbar total pressure was used to form the Xe₂* excimer and produce 172 nm light. There was no gas flow. The voltage was set at 32 volts at the power supply, supplying −32 volts to the oscillator circuit. Electrodes having spheroidal ends as illustrated in FIG. 5 were used, with the spheroidal ends being about 1 mm in diameter. The electrodes were made of stainless steel and, they were separated by about 0.5 mm to about 1 mm. FIG. 8 shows the intensity of the output from the apparatus vs. the wavelength output from the apparatus, and FIG. 9 shows the power output of the apparatus over a period of time.

### EXAMPLE 3

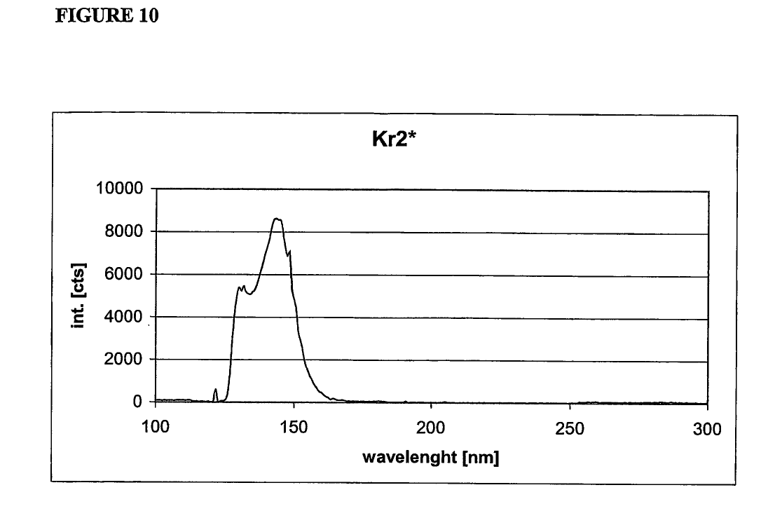

Pure Kr of research grade with a total pressure between about 300 mbar and 1 bar was used to form the Kr₂* excimer and produce 145 nm light. There was no gas flow. The voltage was set at 32 volts at the power supply. Electrodes having spheroidal ends (FIG. 5) were used, with the spheroidal end being about 1 mm in diameter. The electrodes were made of stainless steel and, they were separated by about 0.5 mm to about 1 mm. FIG. 10 shows the intensity of the output of the apparatus vs. the wavelength output from the apparatus.

### EXAMPLE 4

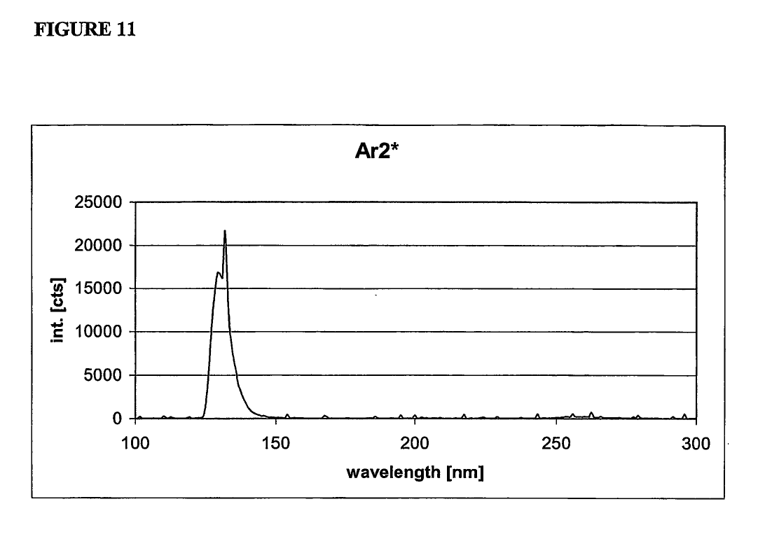

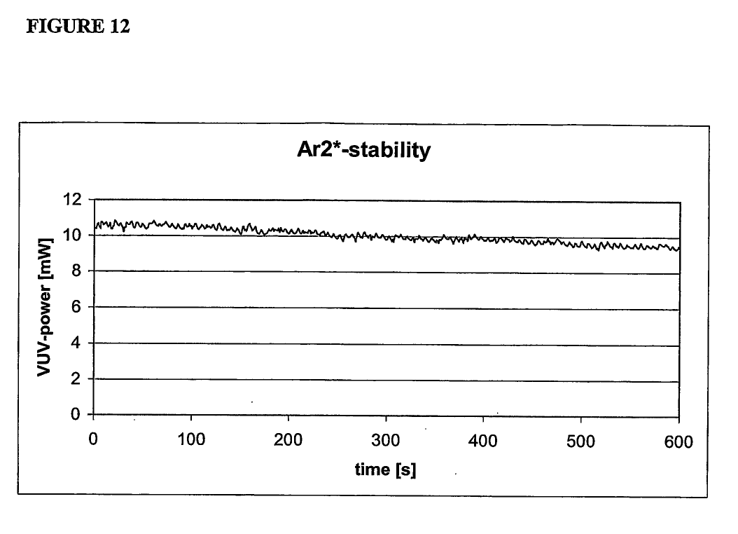

Pure Ar of research grade with a total pressure between about 300 mbar and 1 bar was used to form the Ar₂* excimer and produce 130 nm light. There was no gas flow. The voltage was set at 32 volts at the power supply. Electrodes having spheroidal ends were used, with the spheroidal ends being about 1 mm in diameter. The electrodes were made of stainless steel and, they were separated by about 0.5 mm to about 1 mm. FIG. 11 shows the intensity of the output of the apparatus vs. wavelength output from the apparatus, and FIG. 12 shows the power output of the apparatus over a period of time.

### EXAMPLE 5

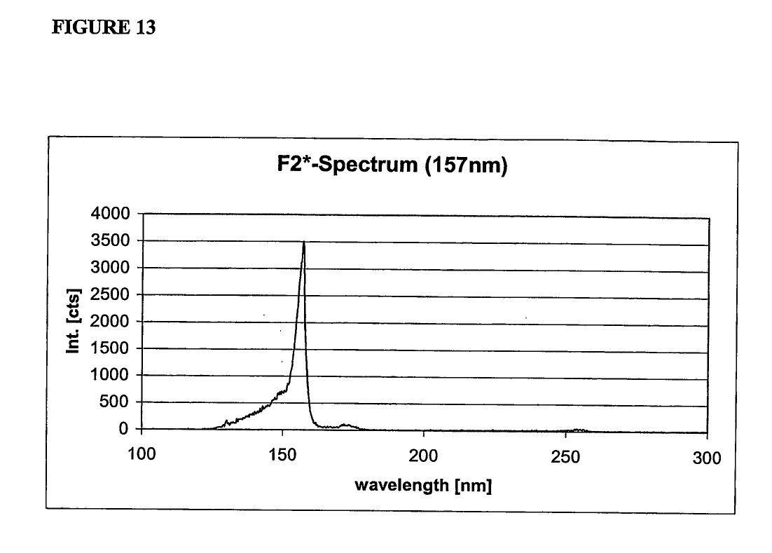

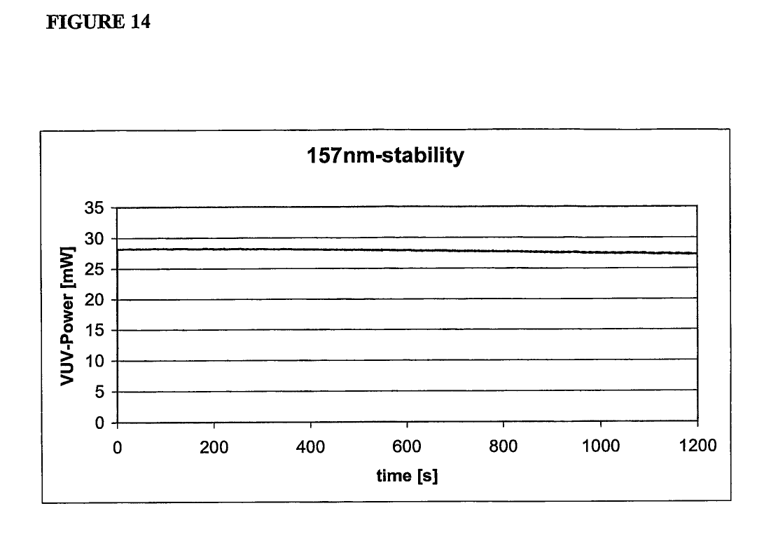

98% He and 2% F₂ at 700 mbar total pressure was used to form the F₂* excimer and produce 157 nm light. The gas flow was approximately about 30 sccm flow of the gas. The voltage was set at 22 volts at the power supply. Brass needle-tip type electrodes as shown in FIG. 3 were used. FIG. 13 shows the intensity of the output of the apparatus vs. the wavelength output from the apparatus, and FIG. 14 shows the power output of the apparatus over a period of time. Similar results were obtained using less rounded brass electrodes (FIG. 4) at about 1 bar total pressure and at −30 volts at the power supply.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

### INDUSTRIAL APPLICABILITY

The present invention can be applied in industries including semiconductor fabrication and chemical production.

1. A method of producing vacuum ultraviolet light, comprising the steps of:
maintaining a gas mixture containing a rare gasand a halogen in a chamber so that at least a portion of said gas mixture is disposed in an emission region between a pair of electrodes at a selected pressure;
applying electrical potential between said electrodes so as to form an electrical discharge in said emission region between said electrodes and apply power to the gases in said emission region at a selected power density to thereby form excimers selected from the group consisting of RGZ* and Z₂* where RG represents a rare gas and Z represents a halogen;
maintaining a concentration of said halogen in the chamber substantially equal to an optimum concentration which maximizes ultraviolet emission from said excimers at said selected pressure and power density.

2. The method as claimed in claim 1, further comprising the step of passing said gas mixture through said chamber at a selected flow rate, wherein said gas mixture passed through said chamber contains an amount of said halogen selected substantially equal to an optimum amount which maximizes said ultraviolet emissions at said selected flow rate, pressure and power density.

3. The method as claimed in claim 2, wherein said selected flow rate is at least about 30 sccm.

4. The method as claimed in claim 1, wherein said selected pressure is at least about 0.3 bar.

5. The method as claimed in claim 1, wherein said power density in said emission region is at least about 20 kW/cm³.

6. The method as claimed in claim 1 wherein said excimers are of the form Z₂*.

7. The method as claimed in claim 6 wherein said gas mixture includes F₂ and said excimers are F₂*.

8. The method as claimed in claim 1, wherein said gas mixture includes a rare gas and a halogen and said excimers are of the form RGZ*.

9. The method as claimed in claim 8 wherein said gas mixture includes argon and fluorine and said excimers are ArF*.

10. The method as claimed in claim 1, wherein said concentration of said halogen in said chamber is between about 1 and about 5%.

11. The method as claimed in claim 1, wherein said concentration of said halogen in said chamber is about 2%.

12. The method as claimed in claim 1, wherein said step of applying electrical potential is performed by applying an alternating potential having a frequency of at least about 100 KHz.

13. The method as claimed in claim 1, wherein said electrodes are needle shaped such that they taper to substantially a point.

14. The method as claimed in claim 1, wherein said electrodes have a rounded shape such that the ends are convexly shaped and are substantially rounded.

15. An apparatus for producing vacuum ultraviolet light, comprised of:
a chamber containing two electrodes defining an emission region therebetween;
a gas at a pressure within said chamber, said gas including a halogen and a rare gas such that the mixture is capable of forming an excimer of the form RGZ or Z₂ where RG represents a rare gas and Z represents halogen; and
a power source for providing electrical potential to said electrodes such that an electrical discharge is formed in said emission region between said electrodes, said power source being adapted to provide a power density between said electrodes, said gas containing an amount of said halogen such that the concentration of said halogen in said emission region is substantially equal to an optimum concentration which maximizes ultraviolet emissions from said excimers of the form RGZ* at said pressure and said power density.

16. The apparatus as claimed in claim 15, further comprising a gas source, said chamber having an inlet opening connected to said gas source and an outlet opening, said gas source, said inlet opening and said outlet opening being adapted to pass said gas through said chamber at a flow rate, said gas containing an amount of said halogen substantially equal to an optimum amount which maximizes said ultraviolet emissions at said flow rate, said pressure and said power density.

17. The apparatus as claimed in claim 16, wherein said flow rate is at least about 30 sccm.

18. The apparatus as claimed in claim 15, wherein said pressure is at least about 0.3 bar.

19. The apparatus as claimed in claim 15, wherein said power density in said emission region is at least about 20 kW/cm³.

20. The apparatus as claimed in claim 15, wherein said concentration of said halogen in said chamber is between about 1 and about 5%.

21. The apparatus as claimed in claim 20, wherein said concentration of said halogen in said chamber is about 2%.

22. The apparatus as claimed in claim 15, wherein said power source is adapted to provide an alternating potential having a frequency of at least about 100 KHz.

23. The apparatus as claimed in claim 15, wherein said electrodes are substantially coaxial with one another and each said electrode is needle shaped such that such electrode tapers to a point adjacent said emission region.

24. The apparatus as claimed in claim 15, wherein said electrodes have a rounded shape such that the ends are convexly shaped and are substantially rounded.

25. The apparatus as claimed in claim 15, wherein at least a portion of said chamber is transparent to said ultraviolet emissions.

26. A method of producing vacuum ultraviolet light, comprising the steps of:
maintaining a gas containing a rare gas in a chamber so that at least a portion of said gas is disposed in an emission region between a pair of electrodes;
applying electrical potential between said electrodes so as to form an electrical discharge in said emission region between said electrodes and apply power to said gas in said emission region, wherein a plasma is formed in said emission region such that said plasma emits ultraviolet light by a radiative process including transition of excimers of the form RG₂ to a lower-energy state; and
maintaining said plasma at a temperature such that the average kinetic energy of gas particles in said discharge region is such that there is only a negligibly small equilibrium population of vibrationally highly excited RG₂* molecules with vibration energy levels close to the binding energy of the RG₂* excimer.

27. The method as claimed in claim 26, wherein said step of maintaining said temperature in said emission region is performed so that said average kinetic energy is less than the vibrational excitation energy of said excimers.

28. The method as claimed in claim 26, further comprising the step of passing said gas through said chamber at a flow rate of at least about 30 sccm.

29. The method as claimed in claim 26, further comprising the step of maintaining said gas in said chamber at a pressure of at least about 0.3 bar.

31. The method as claimed in claim 26, wherein said electrical potential is applied so as to provide a power density of between about 0.1 and about 20 kW/cm³ in said emission region.

32. The method as claimed in claim 26 wherein said rare gas is selected from the group consisting of He, Ne, Kr, Ar, Xe and mixtures thereof.

33. The method as claimed in claim 26, wherein said gas includes Ne and H₂ and said radiative process includes energy transfer from Ne₂* excimers to hydrogen.

34. The method as claimed in claim 33, wherein said gas has a partial pressure of Ne of about 300 to about 1000 mbars and a hydrogen partial pressure of about 0.1 to about 15 mbars.

35. The method as claimed in claim 26, wherein said step of applying said electrical potential is performed so as to provide a power density per unit surface area of each of said electrodes of about 1 W/mm² or less.

36. The method as claimed in claim 45, wherein said electrodes have substantially spheroidal surfaces disposed adjacent said emission region.

37. An apparatus for producing vacuum ultraviolet light, comprised of:
a chamber containing two electrodes defining an emission region therebetween;
gas within said chamber, said gas being comprised of a rare gas that will form an excimer of the form RG₂*, where RG represents said rare gas; and
a power source for providing electrical potential to said electrodes such that an electrical discharge is formed in said emission region between said electrodes, wherein a plasma is formed in said emission region such that said plasma emits ultraviolet light by a radiative process including transition of excimers of the form RG₂ to a lower energy state, and a temperature is maintained in said emission region such that said gas is at a temperature such that the average kinetic energy of gas particles in said discharge region is such that there is only a negligibly small equilibrium population of vibrationally highly excited RG₂* molecules with vibration energy levels close to the binding energy of the RG₂* excimer.

38. The apparatus as claimed in claim 37, wherein said temperature in said emission region is maintained such that said average kinetic energy is less than the vibrational excitation energy of said excimers.

39. The apparatus as claimed in claim 37, further comprising a gas source, said chamber having an inlet opening connected to said gas source and an outlet opening, said gas source, said inlet opening and said outlet opening being adapted to pass said gas through said chamber at a flow rate.

40. The apparatus as claimed in claim 37, wherein said gas in said chamber is at a pressure of at least about 0.3 bar.

41. The apparatus as claimed in claim 37, wherein said power source and said electrodes are arranged to apply said electrical potential at a power density per unit area of each said electrode of about 1 W/mm² or less.

42. The apparatus as claimed in claim 37 wherein each of said electrodes has a surface having an area of at least about 0.75 mm² confronting said emission region.

43. The apparatus as claimed in claim 37, wherein each of said electrodes has a substantially spheroidal surface confronting said emission region.
